(19) United States
(12) Patent Application Publication
(10) Pub. No.: US 2025/0326224 A1
(43) Pub. Date: Oct. 23, 2025

(54) LIQUID EJECTION HEAD AND METHOD FOR MANUFACTURING LIQUID EJECTION HEAD

(71) Applicant: CANON KABUSHIKI KAISHA, Tokyo (JP)

(72) Inventor: HIROAKI SASAKI, Saitama (JP)

(21) Appl. No.: 19/082,479

(22) Filed: Mar. 18, 2025

(30) Foreign Application Priority Data
Apr. 23, 2024 (JP) 2024-069872

(51) Int. Cl. B41J 2/14; B41J 2/16; C09J 11/06; C09J 163/00

(52) U.S. Cl. CPC B41J 2/14; B41J 2/1623; C09J 11/06; C09J 163/00; B41J 2002/14362; B41J 2202/03; B41J 2202/19; B41J 2202/22

(57) ABSTRACT

A liquid ejection head composed of a plurality of members, wherein at least one of a joint between the members is bonded with a cured product of an adhesive, the adhesive is a resin composition comprising at least: (A) an epoxy resin; (B) a liquid aromatic amine curing agent; (C) a liquid acid anhydride curing agent; and (D) a catalyst, an equivalent ratio between the (A) epoxy resin and a total of the (B) liquid aromatic amine curing agent and the (C) liquid acid anhydride curing agent in the resin composition is A:(B+C)=1:1 to 2:3, an equivalent in the equivalent ratio is defined by equivalent=molecular weight/(the number of functional groups×mass of a compound), and the (A) epoxy resin comprises (A-1) a bisphenol A epoxy resin and (A-2) a hydrogenated bisphenol A epoxy resin.

### BACKGROUND OF THE INVENTION

### Field of the Invention

The present disclosure relates to a liquid ejection head for ejecting a liquid such as an ink from an ejection port, and a method for manufacturing the liquid ejection head.

### Description of the Related Art

In a recording method involving a liquid ejection head represented by an ink-jet recording head, thermal energy or vibration energy is applied to a liquid such as an ink, and the ink is ejected as minute droplets from an ejection port to form an image on a recording medium.

As a method for manufacturing this type of liquid ejection head, first, an ejection energy generating element and a wiring conductor for supplying power to the ejection energy generating element are provided on a silicon substrate. After a protective film is provided on the wiring conductor, an ink flow path and an ink ejection port are formed by patterning with a resist. Next, a through hole (ink feeding port) for supplying an ink from the back side of the silicon substrate to the ejection energy generating element part is formed in the silicon substrate, thereby providing a recording element substrate. Then, a support plate made of alumina, resin, or the like is attached to the recording element substrate with an adhesive to electrically join and the recording element substrate and the electric wiring member.

In addition, from the viewpoint of manufacturing costs, the adhesive and sealing material for use in bonding and sealing other members are collectively subjected to main curing in the final step. More specifically, in the step of attaching the support plate and the recording element substrate, the adhesive is not cured yet. Thus, there is a possibility that the attaching accuracy of the recording element substrate positioned at the time of the attachment may be decreased due to the movement to the next step or the like. For the reason described above, it is desirable to temporarily cure (temporarily fix) the adhesive in an apparatus for attaching the substrate for preventing the positional deviation of the recording element substrate. Examples of the adhesive and the sealing material for use in steps other than bonding between the recording element substrate and the support plate include a chip periphery sealing material and an inner lead bonding (ILB) sealing material.

The adhesive to be attached to the recording element substrate (silicon chip) and the support plate (chip plate) is required to have high adhesiveness and ink resistance. In addition, thermosetting one-component epoxy resin compositions are often used because of easy use thereof in manufacturing processes. Powder curing agents are often used because one component epoxy resin requires storage stability.

However, in the case of an adhesive obtained with the use of an epoxy resin that is liquid at normal temperature and a powder curing agent, a bleeding phenomenon is often problematic. This is because crushing, with a silicon chip, the adhesive applied on the chip plate into a thin form, and then curing the thin adhesive cause bleeding out of the epoxy resin, and cause the uncured component to remain. When the remaining uncured component comes into contact with the ink, there is a possibility of causing adhesion of the component to the ink ejection surface and decrease in ink ejection accuracy, and thus, the adhesive for use in the flow path of the ink-jet recording head requires bleeding suppression. For example, Japanese Patent Application Publication No. 2002-302591 discloses an adhesive that can be used for a printer head.

### SUMMARY OF THE INVENTION

In Japanese Patent Application Publication No. 2002-302591, bleeding is considered less likely to occur because no powdered curing agent is used. In Japanese Patent Application Publication No. 2002-302591, an amide-based amine curing agent is used as a curing agent, and a cured product of the adhesive has an amide bond. Because the presence of the amide bond tends to decrease the elastic modulus of the cured epoxy resin, the cured product can serve as a favorable cured epoxy resin with low elasticity and ink resistance. However, the inventor has recognized that depending on the presence state of the amide bond, problems arise in resistance to organic inks.

The present disclosure provides a liquid ejection head including a cured product of an adhesive with low elasticity and favorable temporary fixing property, bleeding resistance, and resistance to many types of ink, and a method for manufacturing the liquid ejection head.

A liquid ejection head composed of a plurality of members, wherein
at least one of a joint between the members is bonded with a cured product of an adhesive,
the adhesive is a resin composition comprising at least:
   (A) an epoxy resin;
   (B) a liquid aromatic amine curing agent;
   (C) a liquid acid anhydride curing agent; and
   (D) a catalyst,
an equivalent ratio between the (A) epoxy resin and a total of the (B) liquid aromatic amine curing agent and the (C) liquid acid anhydride curing agent in the resin composition is A:(B+C)=1:1 to 2:3,
an equivalent in the equivalent ratio is defined by equivalent=molecular weight/(the number of functional groups×mass of a compound), and
the (A) epoxy resin comprises (A-1) a bisphenol A epoxy resin and (A-2) a hydrogenated bisphenol A epoxy resin.

A method of manufacturing the above liquid ejection head,
the manufacturing method comprising a step of bonding at least one of a joint between the members with the adhesive.

According to the present disclosure, a liquid ejection head including a cured product of an adhesive with low elasticity and favorable temporary fixing property, bleeding resistance, and resistance to many types of ink, and a method for manufacturing the liquid ejection head can be provided.

Further features of the present invention will become apparent from the following description of exemplary embodiments with reference to the attached drawings.

### BRIEF DESCRIPTION OF THE DRAWINGS

FIGS. 1A and 1B are schematic views for explaining an example of an ink jet

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

Embodiments of the present disclosure will be described below.

### Liquid Ejection Head

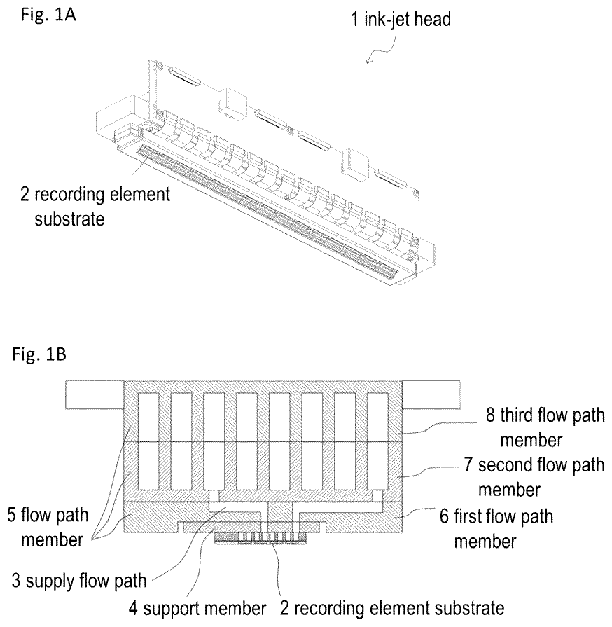

The configuration of an ink-jet head as a liquid ejection head in the present disclosure will be described with reference to the drawings. FIG. 1A is a perspective view of a form of an ink-jet head 1. FIG. 1B is an example of a cross-sectional view of the ink-jet head cut in a direction perpendicular to the ejection port surface (the surface of the ejection port member with ejection ports).

As shown in FIGS. 1A and 1B, the ink-jet head 1, which is a liquid ejection head, is composed of a plurality of members. The ink-jet head 1 includes at least a recording element substrate 2, a supply flow path 3, a support member 4, a flow path member 5. The supply flow path 3 is a flow path for supplying a liquid such as an ink to the recording element substrate 2, and communicates with the recording element substrate 2 from the flow path member 5. The flow path member 5 is a member that forms the supply flow path 3. The support member 4 is a member that is provided between the recording element substrate 2 and the flow path member 5 and fixes the recording element substrate 2 to the flow path member 5.

In the present disclosure, an adhesive can be used for joining these members to each other. Examples of the materials of the members include at least one selected from the group consisting of silicon, silicon nitride, silicon carbide, aluminum, alumina, SUS, titanium, zirconium, tantalum, PPE, POM, and the like.

In the liquid ejection head, at least one of a joint between the members constituting the liquid ejection head is bonded with a cured product of an adhesive. In a manufacturing process for the liquid ejection head, it is necessary to accurately attach two members to each other, such as respective flow path members, and thus, the liquid ejection head may be assembled in accordance with the following procedure. An adhesive is applied to the support member 4 to temporarily fix the recording element substrate 2 in a short time, and thereafter, subjected to main curing. The flow path member 5 is formed by attaching the third flow path member 8 and the second flow path member 7 to each other and further attaching the second flow path member 7 and the first flow path member 6 to each other. Next, the support member 4 and the first flow path member 6 in the flow path member 5 are temporarily fixed. Finally, main curing is performed.

The liquid ejection head preferably has a cured product of an adhesive at a position where the cured product can come into contact with a liquid such as an ink. The liquid ejection head preferably has a cured product of an adhesive at least any of: between the recording element substrate 2 and the support member 4; between the support member 4 and the flow path member 5; and between the respective members that form the flow path member 5 (between the first flow path member 6 and the second flow path member 7, between the second flow path member 7 and the third flow path member 8).

The method for manufacturing the liquid ejection head preferably has a step of bonding at least one of a plurality of a joint between the members with a resin composition. The method for manufacturing the liquid ejection head preferably has a step of applying an adhesive to the support member 4 to temporarily fix the recording element substrate 2, and curing the adhesive. In addition, the method for manufacturing the liquid ejection head preferably has a step of temporarily fixing the support member 4 with the recording element substrate 2 bonded thereto and the flow path member 5, and curing the adhesive.

In addition, the film thickness of the adhesive is preferably reduced for improving the dimensional accuracy after bonding between the members. Particularly, because the large bonding area makes the accuracy deviation liable to be increased in the bonding of the support member or between the flow path member, the members are preferably strongly pressed to each other to make the adhesive thinner also for make the film thickness of the adhesive constant. While bleeding is an issue in this case, bleeding is less likely to occur because a liquid curing agent is used for the adhesive according to the present disclosure. Thus, the adhesive is suitable for bonding between the members.

In addition, while thermal stress is an issue due to differences in linear expansion coefficient in bonding different types of materials, the adhesive according to the present disclosure has low elasticity and relaxes stress, and thus, can be suitably used even if the members are different types of materials. The storage elastic modulus of the cured product of the adhesive at 25° C. and 1.0 Hz is preferably 0.01 to 1.5 GPa, more preferably 0.1 to 1.0 GPa.

The storage elastic modulus can be controlled with the resin composition of the epoxy resin, liquid aromatic amine curing agent, liquid acid anhydride curing agent, and a catalyst.

### Resin Composition of Adhesive

The adhesive for use in the liquid ejection head will be described. The adhesive is a resin composition including at least:
(A) an epoxy resin;
(B) a liquid aromatic amine curing agent;
(C) a liquid acid anhydride curing agent; and
(D) a catalyst.

Further, the (A) epoxy resin includes at least (A-1) a bisphenol A epoxy resin and (A-2) a hydrogenated bisphenol A epoxy resin.

The use of the liquid curing agents improves bleeding resistance.

Furthermore, as a result of intensive studies made by the inventor, the inventor has conceived of an adhesive that achieves both resistance to organic inks and bleeding suppression, and further has a favorable temporary fixing property, with amide bonds formed by not only a reaction between the epoxy and the curing agent but also a reaction between the amine curing agent and the acid anhydride curing agent at the time of heat curing.

The formation of the amide bonds reduces the elasticity, and can relax thermal stress due to a difference in linear expansion when an adherend is made of a different material. However, the inventor has made studies, and recognized that problems may arise in ink resistance if amide bonds are present continuously in the molecule. Accordingly, the inventor has found that the ink resistance is improved by causing amide bonds to be formed randomly at the time of heat curing. The ink resistance is considered excellent as a whole, with the presence of, in the vicinity of amide bonds, a reaction product from the epoxy resin and the liquid aromatic amine curing agent and a reaction product from the epoxy resin and the liquid acid anhydride curing agent, which are better in ink resistance than the amide bonds.

Specifically, an equivalent ratio (A:(B+C)) between the (A) epoxy resin and a total of the (B) liquid aromatic amine curing agent and the (C) liquid acid anhydride curing agent in the resin composition satisfies A:(B+C)=1:1 to 2:3. This ratio is considered to result in a random state, because of the following three reactions:
the reaction between the (A) epoxy resin and the (B) liquid aromatic amine curing agent;
the reaction between the (A) epoxy resin and the (C) liquid acid anhydride curing agent; and
the reaction between a product of the reaction between the (B) liquid aromatic amine curing agent and the (C) liquid acid anhydride curing agent, and the (A) epoxy resin.

In the resin composition, the equivalent ratio (A:(B+C)) between the (A) epoxy resin and the total of the (B) liquid aromatic amine curing agent and the (C) liquid acid anhydride curing agent satisfies A:(B+C)=1:1 to 2:3. Satisfying the equivalent ratio improves the ink resistance and the temporary fixing property in addition to the bleeding resistance, thereby making it possible to obtain a cured product of an adhesive that is lower in elasticity. The inventor presumes the reason therefor as follows. If the ratio of the main agent is higher than this equivalent ratio, the main agent will remain in the reaction, and if the ratio of the curing agents is higher, the curing agent will remain in the reaction. The presence of the unreacted component will decrease the ink resistance lowered, and also decrease the temporary fixing property.

When the amine and acid anhydride of the curing agents reacts with each other, the equivalent ratio of the main agent to the curing agents is shifted, thereby causing defective curing, and thus, the ratio of the curing agents is preferably higher for the equivalent ratio of the epoxy resin to the curing agents.

It is to be noted that in the present disclosure, the equivalent is defined by equivalent=molecular weight/(the number of functional groups×mass of a compound). The functional groups are functional groups involved in the three reactions described above. In the case of the (A) epoxy resin, the functional group is an epoxy group, in the case of the (B) liquid aromatic amine curing agent, the functional group is an amino group, and in the case of the (C) liquid acid anhydride curing agent, the functional group is an acid anhydride group.

Furthermore, from the viewpoint of adhesiveness, the equivalent ratio (B:C) between the (B) liquid aromatic amine curing agent and the (C) liquid acid anhydride curing agent in the resin composition is 1:1 to 4:1.

In addition, the (C) liquid acid anhydride curing agent is not particularly limited, and known curing agents can be used. From the viewpoint of storage stability and ink resistance, the (C) liquid acid anhydride curing agent preferably contains an alicyclic acid anhydride.

The (A) epoxy resin includes at least the (A-1) bisphenol A epoxy resin and the (A-2) hydrogenated bisphenol A epoxy resin. The (A-1) bisphenol A epoxy resin alone may be insufficient in ink resistance and elastic modulus. Also, the (A-2) hydrogenated bisphenol A epoxy resin alone may be insufficient in ink resistance. Because the hydrogenated moiety of the hydrogenated bisphenol A epoxy resin is lower in flatness than the bisphenol A epoxy resin, the ink is considered to become less likely to permeate the resin due to the effect of steric hindrance. Accordingly, including the bisphenol A epoxy resin and the hydrogenated bisphenol A epoxy resin allows both the ink resistance and the low elasticity to be achieved.

The bisphenol A epoxy resin is, for example, a resin obtained by condensation of bisphenol A and epichlorohydrin.

The (A) epoxy resin preferably includes 10% by mass to 80% by mass (more preferably 60% by mass to 80% by mass) of the (A-1) bisphenol A epoxy resin, and 10% by mass to 50% by mass (more preferably 20% by mass to 40% by mass) of the (A-2) hydrogenated bisphenol A epoxy resin. Satisfying the contents mentioned above increases the crosslinking density, and further improves the ink resistance.

In addition, the resin composition of the adhesive preferably further includes an (E) aliphatic amine curing agent. While the ink-jet head is required to have dimensional accuracy, and the resin composition includes the aliphatic amine curing agent, thereby improving the temporary fixing property. The content of the aliphatic amine curing agent is preferably 2 to 30 parts by mass, more preferably 5 to 15 parts by mass, based on 100 parts by mass of the (A) epoxy resin.

The manufacture of the resin composition is not particularly limited, and known methods can be employed. For example, the (A) epoxy resin and the (D) catalyst are mixed and kneaded with a stirring defoamer or the like. Thereafter, a curing agent including the (B) liquid aromatic amine curing agent and the (C) liquid acid anhydride curing agent is added thereto and kneaded with a stirring defoamer or the like, thereby allowing a resin composition to be obtained. The resin composition may contain known additives, if necessary.

The viscosity of the resin composition, measured at 25° C. and 1.0 s⁻¹, is preferably 500 to 100000 mPa·s from the viewpoints of dripping and adhesive thickness at the time of applying the resin composition.

The viscosity is measured with the use of a viscometer (TVE-35H (Toki Sangyo Co., Ltd)). Specifically, a predetermined amount is measured in the cup of the viscometer, and with the cup and the rotor separated from each other at a predetermined gap, the rotor is rotated, and the viscosity value is then read.

The (A) the epoxy resin may include other epoxy resins, in addition to the (A-1) bisphenol A epoxy resin and the (A-2) hydrogenated bisphenol A epoxy resin. For example, cycloaliphatic epoxy resins, aromatic epoxy resins, and aliphatic epoxy resins, which are liquid epoxy resins at normal temperature, may be added.

Examples of the cycloaliphatic epoxy resins include the following:
a polyglycidyl ether of a polyhydric alcohol having at least one cycloaliphatic ring, a cyclohexene oxide structure-containing compound or cyclopentene oxide structure-containing compound obtained by epoxidation of a cyclohexene or cyclopentene ring-containing compound with an oxidizing agent, or a vinylcyclohexane oxide structure-containing compound obtained by epoxidation of a compound that has a vinylcyclohexane structure with an oxidizing agent, and
for example, hydrogenated bisphenol A diglycidyl ether, 3,4-epoxycyclohexylmethyl-3,4-epoxycyclohexyl carboxylate, 3,4-epoxy-1-methylcyclohexyl-3,4-epoxy-1-methylcyclohexane carboxylate, 6-methyl-3,4-epoxycyclohexylmethyl-6-methyl-3,4-epoxycyclohexane carboxylate, 3,4-epoxy-3-methylcyclohexylmethyl-3,4-epoxy-3-methylcyclohexanecarboxylate, 3,4-epoxy-5-methylcyclohexylmethyl-3,4-epoxy-5-methylcyclohexanecarboxylate, 2-(3,4-epoxycyclohexyl-5,5-spiro-3,4-epoxy)cyclohexane-metadioxane, bis(3,4-epoxycyclohexylmethyl)adipate, vinylcyclohexene dioxide, 4-vinylepoxycyclohexane, bis (3,4-epoxy-6-methylcyclohexylmethyl)adipate, 3,4-epoxy-6-methylcyclohexyl carboxylate, methylene bis(3,4-epoxycyclohexane), dicyclopentadiene diepoxide, ethylene glycol di(3,4-epoxycyclohexylmethyl)ether, ethylene bis(3,4-epoxycyclohexanecarboxylate), dioctyl epoxyhexahydrophthalate, and di-2-ethylhexylepoxyhexahydrophthalate.

Specific examples of the aromatic epoxy resins include the following:
a polyglycidyl ether of a polyhydric phenol having at least one aromatic ring or of an alkylene oxide adduct thereof, or an ether including a naphthalene ring, for example, a polyglycidyl ether of bisphenol A, bisphenol F, or a compound obtained by further adding an alkylene oxide thereto, an epoxy novolac resin, a bisphenol A novolac diglycidyl ether, a bisphenol F novolac diglycidyl ether, and the like.

Specific examples of the aliphatic epoxy resins include the following:
a polyglycidyl ether of an aliphatic polyhydric alcohol or an alkylene oxide adduct thereof, a polyglycidyl ester of an aliphatic long-chain polybasic acid, an epoxy-containing compound obtained by oxidizing an aliphatic long-chain unsaturated hydrocarbon with an oxidizing agent, a homopolymer of a glycidyl acrylate or a glycidyl methacrylate, and a copolymer of a glycidyl acrylate or a glycidyl methacrylate. Typical compounds thereof include glycidyl ethers of polyhydric alcohols such as 1,4-butanediol diglycidyl ether, 1,6-hexandiol diglycidyl ether, a triglycidyl ether of glycerin, a triglycidyl ether of trimethylolpropane, a tetraglycidyl ether of sorbitol, a hexaglycidyl ether of dipentaerythritol, a diglycidyl ether of polyethylene glycol, and a diglycidyl ether of polypropylene glycol, and a polyglycidyl ether of a polyether polyol obtained by adding one or more alkylene oxides to an aliphatic polyhydric alcohol such as propylene glycol or glycerin, and a diglycidyl ester of an aliphatic long-chain dibasic acid.

Furthermore, examples thereof include monoglycidyl ethers of aliphatic higher alcohols, and monoglycidyl ethers of phenols, cresols, butylphenols, or polyether alcohols obtained by adding alkylene oxides thereto, glycidyl esters of higher fatty acids, epoxidized soybean oils, octyl epoxystearates, butyl epoxystearates, and epoxidized linseed oils.

In addition, from the viewpoints of flexibility and ink resistance, the epoxy resin includes 10% by mass to 80% by mass of the (A-1) bisphenol A epoxy resin and 10% by mass to 50% by mass of the (A-2) hydrogenated bisphenol A epoxy resin, thereby providing a favorable heat-cured product. The epoxy resin preferably further includes 50% by mass to 80% by mass of the (A-1) bisphenol A epoxy resin and 10% by mass to 30% by mass of the (A-2) hydrogenated bisphenol A epoxy resin. Within the range, a more favorable heat-cured product is obtained.

Specific examples of the (C) liquid acid anhydride curing agent include the following.

Specific examples of the acid anhydride-based curing agents include the following: a dodecenyl succinic anhydride (DDSA), a poly(ethyloctadecanedioic acid) anhydride (SB-20AH), and a poly(phenylhexadecanedioic acid) anhydride (ST-2PAH), and aliphatic acid anhydrides such as a methyltetrahydrophthalic anhydride (Me-THPA), a methylhexahydrophthalic anhydride (Me-HHPA), a methylhymic anhydride (MHAC), a hexahydrophthalic anhydride (HHPA), a tetrahydrophthalic anhydride (THPA), a trialkyltetrahydrophthalic anhydride (TATHPA), a (2-propenyl)butanedioic anhydride, a methylcyclohexenecarboxylic acid (MCTC) and the like as alicyclic acid anhydrides.

Examples of the (B) liquid aromatic amine curing agent includes an amine curing agent containing an aromatic ring. Specific examples thereof include the following: aromatic ring-containing aliphatic polyamines, such as xylylenediamine; and aromatic amines such as 3,5-diethyl-2,4-diaminotoluene, 3,5-diethyl-2,6-diaminotoluene, 4,4′-diaminodiphenylmethane, 2,4-tolylenediamine, 2,6-tolylenediamine, 1,1′-dichloro-4,4′-diaminodiphenylmethane, 3,3′-dichloro-4,4′-diaminodiphenylmethane, 1,1′,2,2′-tetrachloro-4,4′-diaminodiphenylmethane, 1,3,5-triethyl-2,6-diaminobenzene, 3,3′,5,5′-tetraethyl-4,4′-diaminodiphenyl-methane, N,N′-bis(t-butyl)-4,4′-diaminodiphenyl-methane, di(methylthio)toluenediamine, diethyltoluenediamine, dimethylthiotoluenediamine, 4,4′-methylenebis[N-(1-methylpropyl)aniline], aniline, o-toluidine, m-toluidine, and p-toluidine.

Preferred is dimethylthiotoluenediamine.

Other liquid amine-based curing agents other than aromatic amine curing agents may be used to the extent that the effects of the present disclosure are not impaired. Examples of the other liquid amine-based curing agents include the following. As described above, the resin composition preferably further includes an (E) aliphatic amine curing agent, such as the following aliphatic polyamines:
aliphatic polyamines such as ethylenediamine, diethylenetriamine, triethylenetetramine, hexamethylenediamine, and polyoxyalkylene polyamines; and cycloaliphatic polyamines such as isophoronediamine, norbornenediamine, hydrogenated xylylenediamine.

The (D) catalyst is not particularly limited, and known catalysts may be used. For example, imidazole-based catalysts are preferred, and examples thereof include 1-benzyl-2-methylimidazole (1B2MZ).

### EXAMPLES

The present disclosure will be described below with reference to examples and comparative examples, but the present disclosure is not limited thereto.

Table 1 shows the composition ratios (parts by mass) of resin compositions according to the examples and the comparative examples. Next, methods for preparing epoxy resin compositions based on the composition ratios shown in Table 1 will now be described, but the present disclosure is not limited thereto.

### Examples 1 to 5, Comparative Examples 1 to 3 and 5 to 9

For each of the respective examples and comparative examples, the mass of each material of the epoxy resin composition shown in Table 1 was measured. The materials excluding the curing agents were kneaded with the use of a stirring defoamer (HIVIS MIX model 3 from PRIMIX Corporation, 600 rpm, vacuum, 5 min). The remaining curing agents were then added thereto, the mixture was kneaded with a stirring defoamer (600 rpm, vacuum, 5 min), and a syringe was filled with the kneaded product. Thereafter, the resin compositions were used for each of tests.

### Comparative Example 4

The mass of each material of the epoxy resin composition shown in Table 1 was measured, and the materials excluding the curing agents were kneaded with the use of a stirring defoamer (HIVIS MIX model 3 from PRIMIX Corporation, 600 rpm, vacuum 5 min). Thereafter, powdered BTDA was added thereto, and the mixture was then manually stirred. After the powder was sufficiently wet, the wet powder was crushed with three rolls to obtained a kneaded product. The remaining curing agents were then added thereto as in the examples, the mixture was kneaded with a stirring defoamer (600 rpm, vacuum, 5 min), and a syringe was filled with the kneaded product. Thereafter, the resin composition was used for each of tests.

Each of the epoxy resin compositions according to the examples and the comparative examples, blended in accordance with the methods described above, was evaluated in accordance with the following test methods. The results are shown in Table 1.

### Ink Resistance

A cured product of the resin composition was immersed in an ink for service heads (from Canon Inc.), and subjected to an acceleration test at 105° C. for 100 hours, and based on the adhesiveness and mass change before and after the ink immersion, the ink resistance was evaluated.

Specifically, for adhesiveness evaluation, a 2 mm square chip was heated and cured with each of the epoxy resin compositions on a silicon substrate, and then immersed in the above-mentioned ink, and the shear strength was evaluated. The rate of change in shear strength between before and after the immersion was evaluated.

In addition, 2.0 g of the adhesive was cured and immersed in 20 times the amount of ink, and the mass change was evaluated.

For the adhesive strength, the silicon substrate was fixed, and the shear strength of the 2 mm square chip was measured.

The rate of change in adhesive strength was measured before and after the immersion in the ink, and the rate of change was calculated.
A: the mass change of less than 10% between before and after the immersion in the ink, the adhesive strength of 10 kgf or more after the immersion in the ink, and the amount of change of less than 30% in adhesive strength
B: the mass change of 10% or more between before and after in the immersion in the ink, the strength of less than 10 kgf after the immersion in the ink, or the amount of change of 30% or more in adhesive strength

### Bleeding Resistance

The epoxy resin composition was applied to an adherend (PS+PPE resin substrate) to reach a thickness of 100 μm, thereafter, crushed on another adherend to a thickness of 10 μm or 20 μm, and then cured at 100° C. for 1 hour. Thereafter, the adherend was peeled off, and the presence or absence of any uncured component was observed. Thereafter, the bleeding resistance was evaluated in accordance with the following criteria:
A: when the thickness was 10 μm, there was no uncured component
B: when the thickness was 10 μm, there was an uncured component, but when it was 20 μm, there was no uncured component.
C: when the thickness was 20 μm, there was an uncured component

### Elastic Modulus

The epoxy resin composition was cured to prepare a test piece of 5 mm in width, 0.6 mm in thickness, and 20 mm in length, and the storage elastic modulus at 25° C. and 1.0 Hz was measured with the use of a DMA measuring device (DMS 6100 from Hitachi High-Tech Science Corporation).
A: storage elastic modulus of less than 1.5 GPa
B: storage elastic modulus of 1.5 GPa or more and less than 2.5 GPa
C: storage elastic modulus of 2.5 GPa or more

### Temporary Fixing Property

For each of the epoxy resin compositions, the gel time at 130° C. was measured at 100 μm in thickness. The gel time was specifically the measured time for which the epoxy resin composition gelled on a hot plate set at 130° C.
S: Gel Time of less than 20 s.
A: Gel time of 20 s or more and less than 30 s.
B: Gel time of 30 s or more and less than 60 s.
C: Gel time of 60 s or more

As shown in Examples 1 to 5, the epoxy resin and the curing agents at an equivalent ratio of 1:1 to 2:3 result in favorable results for all of the evaluation items. In addition, from Examples 1 to 4, the equivalent ratio between the amine curing agent and the acid anhydride curing agent at 1:1 to 4:1 result in well-balanced epoxy resin adhesives. Example 5 demonstrates that the (E) aliphatic amine curing agent further added further improves the temporary fixing property.

From Comparative Examples 1 to 5, when the amine-based and the acid anhydride-based curing agents are used without being used in combination, problems remain in ink resistance, elastic modulus, and temporary fixing property. Comparative Examples 6 and 7, with the equivalent ratio between the main agent to the curing agent being 1:2 and 2:1, have problems in ink resistance and temporary fixing property, and furthermore, Comparative Example 6 has a problem in elastic modulus. Comparative Examples 8 and 9, with only the bisphenol-type epoxy resin or hydrogenated bisphenol-type epoxy resin used, have problems remaining in required characteristics.

TABLE 1

| | | | Information on Raw | | Example | | | | | | | | |
|---|---|---|---|---|---|---|---|---|---|---|---|---|---|
| Category | | Raw Material | Material | State | 1 | 2 | 3 | 4 | 5 | | | | |
| Main Agent | | jER828 | (A-1) Bisphenol A epoxy | Liquid | 75 | 75 | 75 | 75 | 75 | | | | |
| (parts by | | | resin | | | | | | | | | | |
| mass) | | YX8000 | (A-2) Hydrogenated | Liquid | 25 | 25 | 25 | 25 | 25 | | | | |
| | | | bisphenol A epoxy resin | | | | | | | | | | |
| Curing | Amine- | ETHACURE 300 | (B) Aromatic amine | Liquid | 26 | 40 | 33 | 42 | 26 | | | | |
| Agent | based | ETHACURE 420 | | Liquid | — | — | — | — | — | | | | |
| (parts by | | Hexamethy lenediamine | (E) Aliphatic amine | Liquid | — | — | — | — | 10 | | | | |
| mass) | Acid | RIKACID DDSA | (C) Liquid acid anhydride | Liquid | 68 | 100 | 82 | 27 | 66 | | | | |
| | Anhydride | BTDA | Aromatic acid anhydride | Solid | — | — | — | — | — | | | | |
| Catalyst (parts by | | IB2MZ | Imidazole | Liquid | 1 | 1 | 1 | 1 | 1 | | | | |
| mass) | | | | | | | | | | | | | |
| Equivalent Ratio of A:(B + C) | | | | | 1:1 | 2:3 | 4:5 | 1:1 | 1:1 | | | | |
| Equivalent Ratio of B:C | | | | | 1:1 | 1:1 | 1:1 | 4:1 | 1:1 | | | | |
| Evaluation Item | | Ink Resistance | | | A | A | A | A | A | | | | |
| | | Bleeding Resistance | | | A | A | A | A | A | | | | |
| | | Elastic Modulus | | | A | A | A | A | A | | | | |
| | | Temporary Fixing Property | | | A | A | A | A | S | | | | |
| | | | Information on Raw | | Comparative Example | | | | | | | | |
| Category | | Raw Material | Material | State | 1 | 2 | 3 | 4 | 5 | 6 | 7 | 8 | 9 |
| Main Agent | | jER828 | (A-1) Bisphenol A epoxy | Liquid | 75 | 75 | 75 | 75 | 75 | 75 | 75 | 100 | — |
| (parts by | | | resin | | | | | | | | | | |
| mass) | | YX8000 | (A-2) Hydrogenated | Liquid | 25 | 25 | 25 | 25 | 25 | 25 | 25 | — | 100 |
| | | | bisphenol A epoxy resin | | | | | | | | | | |
| Curing | Amine- | ETHACURE 300 | (B) Aromatic amine | Liquid | 53 | — | — | — | 26 | 53 | 13 | 26 | 26 |
| Agent | based | ETHACURE 420 | | Liquid | — | — | 77 | — | 38 | — | — | — | — |
| (parts by | | Hexamethy lenediamine | (E) Aliphatic amine | Liquid | | | | | | | | | |
| mass) | Acid | RIKACID DDSA | (C) Liquid acid anhydride | Liquid | — | 133 | — | — | — | 132 | 33 | 66 | 66 |
| | Anhydride | BTDA | Aromatic acid anhydride | Solid | — | — | — | 147 | — | — | — | — | — |

| | | | | | | | | | | | | |
|---|---|---|---|---|---|---|---|---|---|---|---|---|
| Catalyst (parts by | IB2MZ | Imidazole | Liquid | — | 1 | 1 | 1 | 1 | 1 | 1 | 1 | 1 |
| mass) | | | | | | | | | | | | |

| Equivalent Ratio of A:(B + C) | | 1:1 | 1:1 | 1:1 | 1:1 | 1:1 | 1:2 | 2:1 | 1:1 | 1:1 |
|---|---|---|---|---|---|---|---|---|---|---|
| Equivalent Ratio of B:C | | — | — | — | — | — | 1:1 | 1:1 | 1:1 | 1:1 |
| Evaluation Item | Ink Resistance | A | B | A | A | B | B | B | B | B |
| | Bleeding Resistance | A | A | C | C | A | A | A | A | A |
| | Elastic Modulus | C | C | C | C | A | C | A | C | A |
| | Temporary Fixing Property | C | C | C | C | A | C | C | A | A |

It is to be noted that regarding the equivalent ratio, for example, with reference to Comparative Example 1, the use of 100 parts by mass of the mixture of the (A) epoxy resin as the main agent with the molecular weight being 400, and the number of epoxy groups being 2, results in A of 2 (=400/(2×100)) in the equivalent ratio. Similarly, B is 2, and the equivalent ratio A:(B+C) is 1:1.

The materials used are as follows.
jER828: Mitsubishi Chemical Co., Ltd.
YX8000: Mitsubishi Chemical Co., Ltd.
ETHACURE 300: dimethylthiotoluenediamine, Mitsui Fine Chemicals, Inc.
ETHACURE 420: 4,4′-methylenebis [N-(1-methylpropyl)aniline], Mitsui Fine Chemicals, Inc.
hexamethylenediamine: Tokyo Chemical Industry Co., Ltd.
RIKACID DDSA: New Japan Chemical Co., Ltd.
BTDA: Sigma-Aldrich
IB2MZ: SHIKOKU KASEI HOLDINGS CORPORATION

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2024-069872, filed Apr. 23, 2024, which is hereby incorporated by reference herein in its entirety.

What is claimed is:

1. A liquid ejection head composed of a plurality of members, wherein
at least one of a joint between the members is bonded with a cured product of an adhesive,
the adhesive is a resin composition comprising at least:
(A) an epoxy resin;
(B) a liquid aromatic amine curing agent;
(C) a liquid acid anhydride curing agent; and
(D) a catalyst,
an equivalent ratio between the (A) epoxy resin and a total of the (B) liquid aromatic amine curing agent and the (C) liquid acid anhydride curing agent in the resin composition is A:(B+C)=1:1 to 2:3,
an equivalent in the equivalent ratio is defined by equivalent=molecular weight/(the number of functional groups×mass of a compound), and
the (A) epoxy resin comprises (A-1) a bisphenol A epoxy resin and (A-2) a hydrogenated bisphenol A epoxy resin.

2. The liquid ejection head according to claim 1, wherein
an equivalent ratio (B:C) between the (B) liquid aromatic amine curing agent and the (C) liquid acid anhydride curing agent in the resin composition is 1:1 to 4:1, and
an equivalent in the equivalent ratio is defined by equivalent=molecular weight/(the number of functional groups×mass of a compound).

3. The liquid ejection head according to claim 1, wherein the (A) epoxy resin comprises 10% by mass to 80% by mass of the (A-1) bisphenol A epoxy resin and 10% by mass to 50% by mass of the (A-2) hydrogenated bisphenol A epoxy resin.

4. The liquid ejection head according to claim 1, wherein the resin composition further comprises (E) an aliphatic amine curing agent.

5. The liquid ejection head according to claim 1, wherein a storage elastic modulus of the cured product of the adhesive at 25° C. and 1.0 Hz is 0.01 to 1.5 GPa.

6. The liquid ejection head according to claim 1, wherein a viscosity of the resin composition at 25° C. and 1.0 s⁻¹ is 500 to 100000 mPa·s.

7. A method of manufacturing the liquid ejection head according to claim 1,
the manufacturing method comprising a step of bonding at least one of the joint between the members with the adhesive.
